(19) United States
(12) Patent Application Publication
(10) Pub. No.: US 2017/0130287 A1
(43) Pub. Date: May 11, 2017

(54) METHOD FOR HEAT TREATMENT, HEAT TREATMENT APPARATUS, AND HEAT TREATMENT SYSTEM

(71) Applicant: KANTO YAKIN KOGYO CO., LTD., Hiratsuka-shi (JP)

(72) Inventors: Shinichi TAKAHASHI, Yokohama-shi (JP); Kiichi KANDA, Hiratsuka-shi (JP)

(21) Appl. No.: 15/409,080

(22) Filed: Jan. 18, 2017

Related U.S. Application Data
(63) Continuation of application No. 14/403,874, filed on Nov. 25, 2014.

(30) Foreign Application Priority Data
Jul. 4, 2012 (JP) 2012-150239

(51) Int. Cl. C21D 9/00; F27D 5/00; F27D 7/02; F27D 19/00; F27D 21/00; F27B 5/10; F27B 5/16; F27B 5/18; F27B 5/12; F27B 5/13; F27B 9/40; F27B 9/38; F27B 9/39; F27B 9/24; F27B 9/36; C21D 1/76; F27D 3/00

(52) U.S. Cl. CPC C21D 9/0043; F27D 3/0024; F27D 5/00; F27D 7/02; F27D 19/00; F27D 21/00; F27B 5/10; F27B 5/16; F27B 5/18; F27B 5/12; F27B 5/13; F27B 9/40; F27B 9/38; F27B 9/39; F27B 9/2407; F27B 9/36; C21D 1/76; F27D 2019/0006; F27D 2019/0012; F27D 2019/0059; F27B 2009/382; F27B 2009/384

(57) ABSTRACT

A method for heat treatment, a heat treatment apparatus, and a heat treatment system that is capable of performing highly precise and efficient control of heat treatment. A heat treatment furnace has in-furnace structures made of graphite and has a heat-treatment chamber in which heat treatment of materials to be treated is performed. A value of ΔG⁰ (standard formation Gibbs energy) is computed with reference to the sensor information from respective sensors, and an Ellingham diagram, a control range, and a status of the heat treatment furnace in operation expressed by ΔG⁰ are displayed on a display device. A control unit controls a flow rate of neutral gas or inactive gas as atmosphere gas or a flow velocity of the gas so that ΔG⁰ is within the control range.

### CROSS-REFERENCE TO RELATED APPLICATIONS

The present application is a continuation application of U.S. patent application Ser. No. 14/403,874, filed on Nov. 25, 2014, which is a National Phase Entry of International Application No. PCT/JP2013/066378, filed on Jun. 13, 2013, which claims priority from Japanese Application No. 2012-150239, filed on Jul. 4, 2012, the disclosure of which is hereby incorporated by reference herein in its entirety.

### TECHNICAL FIELD

The present invention relates to a method for heat treatment, a heat treatment apparatus, and a heat treatment system. More particularly, the present invention relates to a method for heat treatment, a heat treatment apparatus, and a heat treatment system, configured to supply atmosphere gas, which is constituted of neutral gas or inactive gas, to a heat-treatment chamber having in-furnace structures and the like made of graphite so as to perform heat treatment of materials to be treated, while performing highly precise control by using Ellingham diagram information.

### BACKGROUND ART

For heat treatment of metal, various heat treatments have conventionally been used depending on application purposes, the heat treatments including a standardization treatment such as annealing/normalizing, a hardening/toughening treatment, such as quenching/tempering and thermal refining, a surface hardening treatment, such as nitriding and surface improvement, and brazing and sintering of metal products. While these atmosphere heat treatments are performed in atmosphere gases, such as atmospheric air, inert gases, oxidizing gases, and reducing gases, which are supplied to a heat treatment furnace, the properties of metals that are subjected to the heat treatments are drastically changed by components of these atmosphere gases. Accordingly, it is necessary to control the components of the atmosphere gases supplied into the heat treatment furnace with sufficient precision and to visualize the status of the atmosphere in the furnace with high precision.

As a first conventional technology that performs feedback control on the flow rate of the gas supplied to a heat treatment furnace in response to a signal coming from an oxygen potentiometer placed inside the heat treatment furnace, a method of adjusting the atmosphere gas in a bright annealing furnace disclosed in Patent Literature 1 (Japanese Patent Laid-Open No. 3-2317) will be described with reference to FIG. 1. In FIG. 1, exothermic converted gas is supplied from an exothermic converted gas generator 11 to a gas mixer 13 via a dehumidifier 12, while hydrocarbon gas is supplied from a hydrocarbon gas feeder 14 to the gas mixer 13 via a flow control valve V1 so that the hydrocarbon gas is mixed with the exothermic converted gas.

The mixed gas is heated and combusted at high temperature (1100° C.) in a gas converter with heating function 15, and then the gas is quenched and dehumidified in a gas quenching/dehumidifier system 16, before being supplied to a bright annealing furnace 17. Oxygen partial pressure is measured by the oxygen potentiometer 18 provided inside the bright annealing furnace 17, and based on this measurement value, carbon potential (CP) is calculated by a carbon potential computation controller 19. Then, the calculated value is compared with a preset carbon content in an object to be treated, and the flow rate of hydrocarbon gas supplied to the gas mixer 13 is feedback-controlled via the flow control valve V1 so that the calculated value is matched with the preset carbon content. This prevents oxidation and decarbonization of the material to be treated in the bright annealing furnace 17.

Next, as a second conventional technology, a method of controlling furnace gas in bright heat treatment disclosed in Patent Literature 2 (Japanese Patent Laid-Open No. 60-215717) will be described with reference to FIG. 2.

In FIG. 2, an oxygen analyzer 22 detects the partial pressure of residual oxygen in a heat chamber 21. When the detection value is higher than a set value set in an oxygen partial pressure setting unit 24, hydrocarbon gas and reducing gas are supplied to the heat chamber 21, whereas when the detection value is lower than the set value, oxidizing gas such as air is supplied to the heat chamber 21 so as to control the amount of residual oxygen to be constant.

A carbon monoxide analyzer 23 also detects the partial pressure of residual carbon monoxide in the heat chamber 21, and when the detection value is higher than a set value set in a carbon monoxide partial pressure setting unit 25, inert gas, such as nitrogen, is discharged to the outside of the furnace while being supplied to the heat chamber 21, so that the amount of residual carbon monoxide is controlled to be constant. As a consequence, even when moisture, oxides, and oil and fat adhere to the surface of metals to be treated, the bright treatment is implemented without causing oxidation, decarbonization, carbon deposition, and carburization.

As a third conventional technology, a method of calculating heat treatment conditions by using an Ellingham diagram to reduce metal oxide to metal is disclosed in Patent Literature 3 (WO 2007/061012).

Moreover, as a fourth conventional technology, Patent Literature 4 (Japanese Patent No. 3554936) discloses a technology that forms a carbon wall as an inner wall of a furnace, supplies inactive gas such as nitrogen gas, other than hydrogen, as furnace atmosphere to cause a reaction between oxygen and the carbon wall to generate carbon monoxide (CO), and sinters a molded product made of metal powder under reducing atmosphere achieved with the carbon monoxide (CO). In this method, there is no concern about hydrogen explosion over a wide temperature range, and a small amount of residual oxygen O₂ reacts with solid carbon in the inner wall of the furnace so that an equilibrium state of carbon is automatically maintained in accordance with heat treatment temperature, which prevents generation of excessive carbon.

As a fifth conventional technology, Patent Literature 5 (Japanese Patent No. 3324004) discloses a technology that forms a carbon wall as an inner wall of a furnace, and brazes stainless steel by using a conveyer belt made of carbon under a furnace atmosphere constituted of argon gas.

Furthermore, as a sixth conventional technology, Non Patent Literature 1 (Keikinzoku (Light Metals) Vol. 57, No. 12) discloses a technology that uses a continuous nonoxidizing atmosphere including in-furnace structures made of graphite, such as graphite heat insulators, graphite inner/outer muffles, graphite heaters, and graphite conveyance belts, and supplies argon gas or nitrogen gas to this continuous nonoxidizing atmosphere furnace so as to braze titanium under an oxygen partial pressure of 10⁻¹⁵ Pa or less. As in the fourth conventional technology, this furnace is free from concern about hydrogen explosion and is capable of thermally dissociate difficult-to-reduce metal oxides, so that the surface of metal to be treated can substantially be deoxidized.

### CITATION LIST

### Patent Literature

Patent Literature 1: Japanese Patent Laid-Open No. 3-2317
Patent Literature 2: Japanese Patent Laid-Open No. 60-215717
Patent Literature 3: WO 2007/061012
Patent Literature 4: Japanese Patent No. 3554936
Patent Literature 5: Japanese Patent No. 3324004
Non Patent Literature 1: Keikinzoku (Light Metals) Vol. 57, No. 12, pp 578-582, December in 2007

### SUMMARY OF INVENTION

### Technical Problem

The first conventional technology in Patent Literature 1 is configured so that the gas converter with heating function 15 combusts hydrocarbon gas and exothermic converted gas at high temperature to generate atmospheric gas. This causes various problems, including concern about explosion due to the use of explosible gas, increase in both size of the apparatus itself and power consumption, and difficulty in control due to complicated atmosphere control caused by change in carbon potential (CP) by temperature.

A furnace gas control method in the bright heat treatment disclosed in Patent Literature 2 has the problem stated in Patent Literature 1. In addition, although there is a description about controlling the residual oxygen amount and the residual carbon monoxide amount to be constant, no description is provided regarding how to determine a preferred condition range, i.e., the range of the bright treatment which does not cause decarbonization.

Furthermore, in Patent Literature 3 that discloses a metal, a method and apparatus for manufacturing the metal, and an application thereof, there is a description about reducing metal oxides to produce metal with reference to an Ellingham diagram representative of an equilibrium state of a reaction system with ΔG⁰ as an ordinate and temperature as an abscissa. However, it is impossible to identify where, in the preferred condition range and in the condition range out of the preferred conditions, the furnace is currently operated. Moreover, in the case where, for example, the preferred condition is changed, it is impossible to dynamically cope with the change. Furthermore, there is no description regarding analyzing the operation conditions of the furnace based on optimum set conditions and signals from the sensors by using an operation history in the case where defective articles are generated in mass production, and performing failure analysis of a lot that includes the defective articles.

Although calculating ΔG⁰ is mentioned in paragraph [0011] in which the metal, the method and apparatus for manufacturing the metal, and the application thereof in Patent Literature 3 are described, there is no description whatsoever regarding use of ΔG⁰ as a means for displaying the status of the heat treatment furnace in operation and how to control the status of the heat treatment furnace expressed by ΔG⁰.

Moreover, a method of sintering metal disclosed in Patent Literature 4, a brazing method disclosed in Patent Literature 5, and a method of brazing industrial unalloyed titanium with the continuous nonoxidizing atmosphere furnace disclosed in Non Patent Literature 1 are similar to those in the present invention in the point of supplying neutral gas or inactive gas to the heating chamber constituted from a graphite muffle. However, in the case of the heat treatment methods disclosed in Patent Literatures 1 to 3, there is no description or suggestion about displaying the status of the heat treatment furnace in operation on a display device as a point on an Ellingham diagram in real time.

In all the documents stated above, no disclosure is made about visualizing the current status of atmosphere in the furnace with high precision and controlling the status of the furnace by using the visualized information.

### Solution to Problem

The present invention provides a method for heat treatment, a heat treatment apparatus, and a heat treatment system which suitably solved the aforementioned problems.

A heat treatment apparatus of the present invention includes: a heat treatment furnace that heat-treats materials to be treated; a gas supply device that supplies atmosphere gas constituted of neutral gas or inactive gas to the heat treatment furnace; a control system that controls a flow rate from the gas supply device by referring to sensor information from a sensor, wherein the heat treatment furnace has in-furnace structures made of graphite, the heat treatment apparatus further including: a standard formation Gibbs energy computation unit that calculates standard formation Gibbs energy of the heat treatment furnace by referring to the information from the sensor; and a display data generation unit that generates the standard formation Gibbs energy as display data to be displayed on the Ellingham diagram corresponding to temperature of the heat treatment furnace.

The neutral gas or inactive gas may be any one of nitrogen gas, argon gas, and helium gas.

The standard formation Gibbs energy may be sampled in temporal sequence, a difference value between temporally adjacent data pieces may be calculated, and time at which the different value is equal to 0 may be calculated as reduction finish time of the materials to be treated.

The heat treatment apparatus may include: a conveyance mechanism that conveys the plurality of materials to be treated in sequence in a longitudinal direction of the heat treatment furnace; and sensors that are provided in a plurality of places along the longitudinal direction to calculate the standard formation Gibbs energy, wherein the standard formation Gibbs energy may be calculated in the respective places with reference to respective signals from the plurality of sensors, and a conveyance rate may be controlled by the conveyance mechanism, or a flow rate of the neutral gas or inactive gas or a flow velocity of the gas may be controlled, so that the calculated value falls within a control range.

The display data generation unit may generate the display data including a control range of the heat treatment furnace in the Ellingham diagram.

Moreover, the control range may include: a first control range indicative of a normal operation range of the heat treatment furnace; a second control range outside the first control range, wherein when a status on the Ellingham diagram is out of the first control range and goes into the second control range, an alarm is output but operation is continued; and a third control range outside the second control range, wherein when the status goes into the third control range, operation of the heat treatment apparatus is stopped.

The standard formation Gibbs energy computation unit may perform computation by using any one information piece of oxygen partial pressure and carbon monoxide partial pressure or both information pieces to calculate the standard formation Gibbs energy.

The standard formation Gibbs energy computation unit may further calculate the standard formation Gibbs energy by any one of a computation method with use of an oxygen sensor, a computation method with use of a carbon monoxide sensor, and a computation method with use of the information from both sensors.

The heat treatment apparatus may include a status monitoring & abnormality processing unit that directly monitors a status on the Ellingham diagram, outputs an alarm when the status deviates from the first control range, and outputs control information so as to stop the operation of the heat treatment apparatus when the status shifts to the third control range.

The heat treatment apparatus may include a heat treatment database that stores at least one of process information on the materials to be treated, log information about operation of the heat treatment apparatus, and accident information.

Moreover, a plurality of process conditions for evaluation may be set for the materials to be treated, the materials to be treated that are heat-treated in each of these conditions are evaluated, and the control range may be defined based on the evaluation results.

When a lot number of the materials to be treated is specified in case where the status of the materials to be treated shifts in sequence, the Ellingham diagram of the materials to be treated may sequentially be displayed on an identical screen or a plurality of screens.

The heat treatment database may include, a file of materials to be treated that stores a list or a library of the materials to be treated including at least one of various metals and alloys including carbon steel, and steel, nickel (Ni), chromium (Cr), titanium (Ti), silicon (Si) and copper (Cu) containing an alloy element. The heat treatment database may also include a process control file that stores a list or a library of the heat treatments including at least one of a bright treatment, a refining treatment, a hardening/tempering treatment, brazing, and sintering.

Further, the heat treatment apparatus may include a display device that simultaneously or switchingly displays at least two or more out of the Ellingham diagram, a chart indicative of time transition in control parameter of the heat treatment apparatus, and the information from the sensor.

The sensor and the control system may be connected via a communication line, so that the control system may monitor in real time whether the sensor and the communication line normally operate, while performing offset correction and noise correction of a signal from the sensor.

The heat treatment system of the present invention may include: a heat treatment furnace that heat-treats materials to be treated; a gas supply device that supplies atmosphere gas constituted of neutral gas or inactive gas to the heat treatment furnace; a control system that controls a flow rate from the gas supply device by referring to sensor information from a sensor, wherein the heat treatment furnace may have in-furnace structures made of graphite, and include a heat-treatment chamber in which heat treatment of the materials to be treated is performed. The heat treatment apparatus may further include: a standard formation Gibbs energy computation unit that calculates the standard formation Gibbs energy of the heat treatment furnace by referring to the information from the sensor; a display data generation unit that generates an Ellingham diagram of the heat treatment furnace and the standard formation Gibbs energy as display data to be displayed on the Ellingham diagram according to temperature of the heat treatment furnace; and a terminal device that displays the display data via a communication line, while transmitting the control information for controlling the control system.

A method for heat treatment of the present invention may be a method for heat treatment that heat-treats materials to be treated in a heat-treatment chamber provided in a heat treatment furnace, the method comprising: making in-furnace structures of the heat treatment furnace from graphite; supplying atmosphere gas constituted of neutral gas or inactive gas to the heat treatment furnace; calculating standard formation Gibbs energy of the heat treatment furnace by referring to sensor information from respective sensors that detect a status during heat treatment; and generating an Ellingham diagram of the heat treatment furnace and the standard formation Gibbs energy as display data to be displayed on the Ellingham diagram according to temperature of the heat treatment furnace.

### Advantageous Effects of Invention

The method for heat treatment, the heat treatment apparatus, and the heat treatment system according to the present invention can display an Ellingham diagram, a control range, and an operational status of the heat treatment furnace on a display device, so that the operational status of the heat treatment furnace can be monitored in real time from a perspective of the Ellingham diagram.

The method for heat treatment, the heat treatment apparatus, and the heat treatment system according to the present invention can grasp whether or not the status of the heat treatment furnace is within the control range set on the Ellingham diagram and two-dimensionally grasp a margin to a boundary of the control range when the status is in the control range. Furthermore, the control range is divided into a normal operation range, an alarm output/continuous operation range set outside the normal operation range, and an operation stop range set further outside the alarm output/continuous operation range to normalize a control method in each range, so as to achieve decrease in occurrence rate of a defective lot and reduction in operation stop period. As a consequence, the heat treatment apparatus excellent in mass productivity can be provided.

Further in the method for heat treatment, the heat treatment apparatus, and the heat treatment system according to the present invention, sensor signals regarding the operational status, shift in system status on the Ellingham diagram and the like are stored as log data, which makes it easy to perform failure analysis and the like. Moreover, alarm information can be sent to persons concerned before fatal shutdown occurs, and quick recovery to the normal operation condition can be implemented.

Further in the method for heat treatment, the heat treatment apparatus, and the heat treatment system according to the present invention, data about materials to be treated and treatment processes is stored in a database as libraries. When the materials to be treated and the treatment processes are changed, it becomes possible to swiftly switch the operation of the heat treatment furnace by selecting these libraries. Therefore, the present invention is also applicable to limited manufacture with a wide variety.

Furthermore, when the method for heat treatment, the heat treatment apparatus, and the heat treatment system according to the present invention are applied to bright annealing heat treatment, it becomes unnecessary to execute after-treatments, such as acid pickling performed after the heat treatment, since the product surface is bright-finished, or it becomes possible to omit a process of removing a decarburized layer (such as cutting, etching and polishing) after the heat treatment since there is no decarbonization on the surface in process of the heat treatment.

Since hydrogen gas is not used, there is no concern about explosion during heat treatment, so that extremely safe operation is realized for the heat treatment furnace.

If the flow rate of reducing gas, such as hydrocarbon gas, is increased to enhance the reducing property in the conventional heat treatment furnace, soot may be generated in the heat treatment furnace and contaminate the heat treatment furnace with carbon, and/or the materials to be treated may be carburized. In the case of heat treatment such as the bright treatment and annealing, it is difficult to perform atmosphere control to prevent carburization and decarbonization, since the carbon potential (CP) changes with temperature.

In contrast, the method for heat treatment, the heat treatment apparatus, and the heat treatment system according to the present invention does not use any reducing gas such as hydrocarbon gas, which eliminates the possibility of soot generation. Since only neutral gas or inactive gas is supplied to a heat treatment furnace, carburization and decarbonization do not occur in the materials to be treated.

Since the flow rate or flow velocity of neutral gas or inactive gas supplied from the supply source of the gas is adjusted with a flow control valve, control of atmosphere gas can considerably be simplified.

In the case of heat-treating easy-to-reduce materials to be treated, such as copper, control is performed so that the status of the heat treatment furnace falls within a control range set on the Ellingham diagram. As a result, the flow rate of the neutral gas or inactive gas supplied to the heat treatment furnace can considerably be reduced as compared with difficult-to-reduce materials to be treated. This makes it possible to curtail the expense of gas accordingly.

Since the oxygen partial pressure in the heat treatment furnace can be maintained extremely low (10⁻¹⁵ Pa or lower), it becomes possible to perform heat dissociation of metal oxides which are extremely difficult to reduce, and to thereby perform heat treatment of metal in a deoxidized state.

Moreover, in the method for heat treatment and the heat treatment apparatus according to the present invention, heat treatment is performed while the heat treatment furnace is maintained at about 1 atmospheric pressure. Accordingly, as compared with the conventional heat treatment furnace having a vacuum furnace, evaporation from materials to be treated can considerably be decreased.

Moreover, in the method for heat treatment, the heat treatment apparatus, and the heat treatment system according to the present invention, the need for a gas converter that combusts hydrocarbon gas to generate conversion gas is eliminated, so that the entire apparatus can be downsized. This eliminates the necessity of supplying electric power to the gas converter, so that considerable power reduction in the entire apparatus can be achieved.

### BRIEF DESCRIPTION OF DRAWINGS

FIG. 1 is a block diagram representing a bright annealing furnace in a first conventional technology.

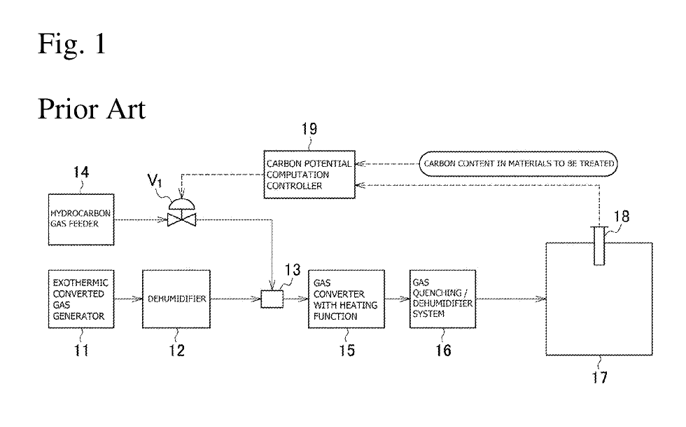

FIG. 2 is a block diagram illustrating an automatic controller of a bright heat treatment furnace in a second conventional technology.

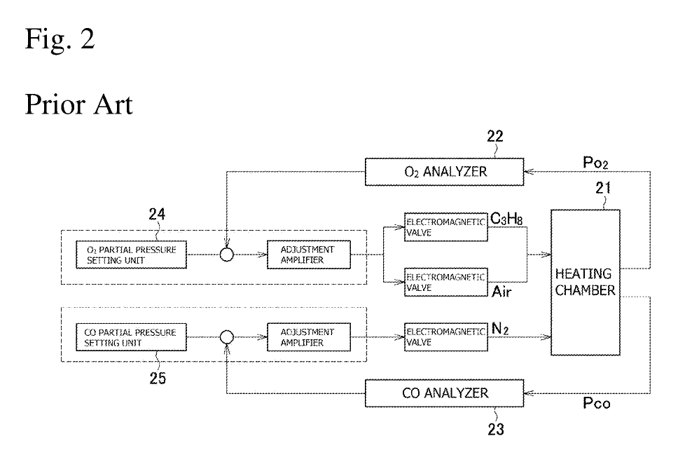

FIG. 3 is a block diagram illustrating the schematic configuration of a heat treatment apparatus and a heat treatment system according to an embodiment of the present invention.

FIG. 4 is a cross sectional view of the heat treatment furnace according to an embodiment of the present invention.

FIGS. 5(a), 5(b) and 5(c) are explanatory views for describing a reduction reaction in the heat treatment apparatus according to an embodiment of the present invention.

FIG. 6 is a detailed block diagram of a control system illustrated in FIG. 3.

FIG. 7 is an explanatory view for describing time change in temperature and ΔG⁰ in the case where the heat treatment furnace according to the present invention is a batch furnace.

FIG. 8 is an exemplary cross sectional view of a heat treatment furnace along a longitudinal direction when the heat treatment apparatus according to the present invention is applied to a continuous furnace.

FIG. 9 illustrates change in ΔG⁰ with the position of the continuous heat treatment furnace including positions 81, 82, and 83 illustrated in FIG. 8 as an abscissa.

FIG. 10 is a block diagram illustrating a concrete configuration example of a heat treatment database illustrated in FIGS. 3 and 6.

FIG. 11 is an explanatory view of a control range of the present invention.

FIG. 12 is an explanatory view of the behavior of a status when the status shifts between the control ranges of the present invention.

FIG. 13 is a flow chart illustrating a method for heat treatment of the present invention.

FIGS. 14(A) and 14(B) illustrate display examples displaying a time change in control parameter on a display device of the present invention.

FIGS. 15(A), 15(B) and 15(C) illustrate display examples of the display device of the present invention.

FIG. 16 is a flow chart illustrating a method of determining the control range of the present invention.

FIG. 17 is an explanatory view of a relationship between different heat treatments and statuses corresponding to these heat treatments on the Ellingham diagram in the method for heat treatment of the present invention.

### DESCRIPTION OF EMBODIMENTS

Hereinafter, the embodiments of a method for heat treatment, a heat treatment apparatus, and a heat treatment system of the present invention will be described with reference to the drawings.

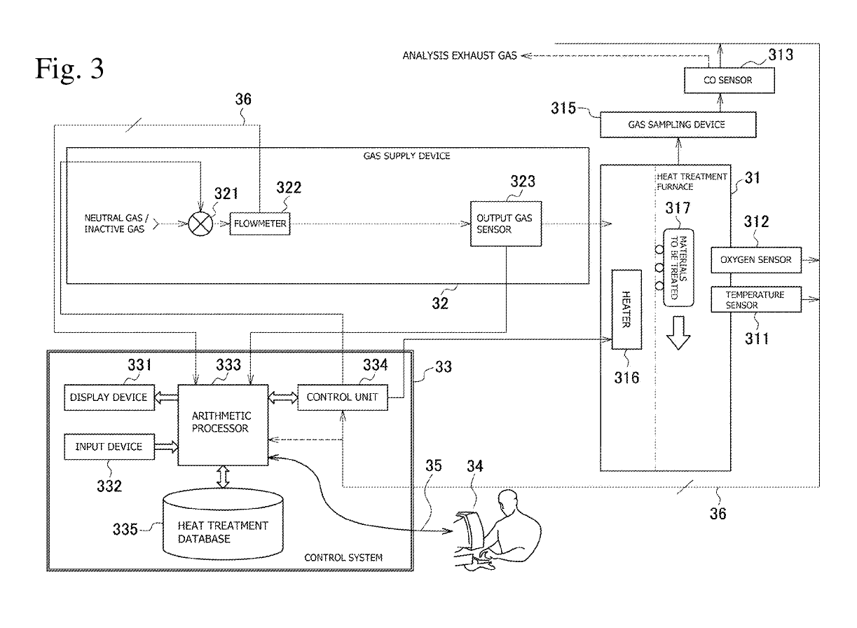

FIG. 3 is a block diagram illustrating the schematic configuration of the heat treatment apparatus and the heat treatment system of the present invention. Materials to be treated 317 brought into a heat treatment furnace 31 are subjected to heat treatment such as a bright treatment, a refining treatment, a hardening/tempering treatment, brazing, and sintering, in neutral gas such as nitrogen gas or in inactive gas such as argon gas and helium gas at a specified high temperature set by a heater 316.

A gas supply device 32 supplies atmosphere gas constituted of neutral gas or inactive gas to the heat treatment furnace 31. A control system 33 controls temperature of the heat treatment furnace 31 and the like and controls the gas supply device 32 and the like in response to signals from various sensors. A terminal device 34 reciprocally inputs and outputs information via a control system 33 and a communication line 35.

The heat treatment furnace 31 includes various sensors including, more particularly, a temperature sensor 311 that measures temperature, and an oxygen sensor 312 that measures residual oxygen partial pressure (O₂ partial pressure).

The heat treatment furnace 31 also includes a carbon monoxide sensor (CO sensor) 313 that samples a part of atmosphere gas in the heat treatment furnace 31 with a gas sampling device 315, and measures a carbon monoxide partial pressure (CO partial pressure) inside the heat treatment furnace 31 based on the sampled atmosphere gas. The atmosphere gas analyzed with the carbon monoxide sensor (CO sensor) 313 is discharged as analysis exhaust gas.

Although the temperature sensor is an indispensable sensor, it is not necessary to provide all the other sensors. More specifically, there are following methods of measuring standard formation Gibbs energy ΔG⁰ of the heat treatment furnace 31: (1) a method of using the carbon monoxide sensor (CO sensor) 313; (2) a method of using the oxygen sensor 312; and (3) a method of using a combination of the methods (1) and (2). In accordance with these methods (1) to (3), necessary sensors may be provided.

The gas supply device 32 includes a flow control valve 321 that controls a flow rate or a flow velocity of neutral gas or inactive gas in response to control signals of a control unit 334, a flowmeter 322 that measures neutral gas or inactive gas whose flow rate or flow velocity has been adjusted, and an output gas sensor 323 that measures a dew point or an oxygen partial pressure of the gas supplied to the heat treatment furnace 31.

Note that the output gas sensor 323 is provided in order to detect deviation of the dew point from a normal control range due to occurrence of abnormalities in the gas supply device 32, and the like. However, the precision of the dew-point sensors which are currently available on the market leaves much to be desired. Accordingly, instead of using the dew-point sensor as the output gas sensor 323, a method of using information from an oxygen sensor and the like may be used to detect whether or not the output gas from the gas supply device 32 is normal.

Based on the signals from the output gas sensor 323, the control unit 334 or an arithmetic processor 333 determines whether or not the dew point and the like are within the control range. When the dew point is determined to be within the control range, neutral gas such as nitrogen gas or inactive gas such as argon gas and helium gas is supplied to the heat treatment furnace 31 from the gas supply device 32.

The control system 33 has a display device 331 that displays an operational status of the heat treatment furnace, more specifically, a point that represents the status on an Ellingham diagram, and information such as a control range set on the Ellingham diagram. The control system 33 also has an input device 332 that outputs input information to an arithmetic processor 333. Further, there is provided an arithmetic processor 333 that uses signals from various sensors placed inside the heat treatment furnace 31 and from the CO sensor 313 provided outside the heat treatment furnace 31 and uses the information stored in a heat treatment database 335 to perform arithmetic processing. The arithmetic processor 333 also outputs control signals for controlling the flow control valve 321 and the like to the control unit 334. There are also provided the control unit 334 that controls the heater 316, the flow control valve 321 and the like in response to the control signals from the arithmetic processor 333, and the heat treatment database 335 that stores and manages material information on the materials to be treated 317, process information about the heat treatment, information about the control range, log information about operation of the heat treatment apparatus, accident data, and the like.

Moreover, the various sensors, such as the temperature sensor 311, the oxygen sensor 312, and the CO sensor 313, are connected to the control unit 334 or the arithmetic processor 333 via the communication line 36, such as a dedicated sensor bus, a general-purpose bus, or a wireless LAN. The control unit 334 or the arithmetic processor 333 monitors in real time whether or not the various sensors and the communication line 36 normally operate, while performing processing such as detection of signals from various sensors, sampling, A/D conversion, waveform equivalence, offset correction, and noise correction.

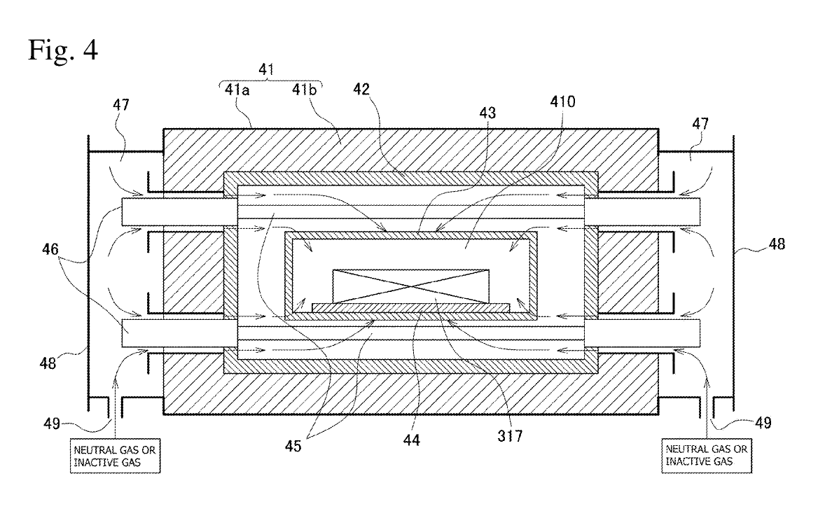

Next, the heat treatment furnace 31 will be described in detail with reference to FIG. 4. FIG. 4 is a cross sectional view illustrating an exemplary configuration of the heat treatment furnace 31. The heat treatment furnace 31 has an outer wall 41 made up of a metal outer wall 41a that seals the entire heat treatment furnace 31 against the atmosphere and a graphite heat insulator 41b that is in contact with the inner side of the metal outer wall 41a to keep the heat-treatment chamber 410 warm. A tunnel-like graphite outer muffle 42 formed from graphite is placed inside a hollow surrounded with the graphite heat insulator 41b. Here, a part of the graphite heat insulator may be a ceramic heat insulator when the temperature is about 1200° C. or less.

In the graphite outer muffle 42, a tunnel-like graphite inner muffle 43 formed from graphite is provided. The inside of this graphite inner muffle 43 serves as a heat-treatment chamber 410 in which heat treatment of the materials to be treated 317 is performed. The temperature of the heat-treatment chamber 410 is set at 800° C. to 2400° C. in one example. Graphite heaters 45 are placed on upper and lower directions of the graphite inner muffle 43 to heat the heat-treatment chamber 410. Each of the graphite heater 45 is made to pass through the graphite outer muffle 42 in a horizontal direction and is attached to the outer wall 41 via a bush 46.

Inside the heat-treatment chamber 410, a mesh belt 44 made of a C/C composite material is provided so as to be movable in a longitudinal direction along the lower side of the graphite inner muffle 43. The materials to be treated 317 are laid on the mesh belt 44 and are moved at a set velocity inside the heat-treatment chamber 410, together with the mesh belt 44, in a direction vertical to the page. When the temperature of the heat-treatment chamber 410 is 1000° C. or less, a mesh belt made of refractory metal may be used instead of the mesh belt made of a C/C composite material. A silicon carbide heater may be used instead of the graphite heater.

A heater box 47 hermetically formed from a metal plate material 48 is provided on both right and left sides of the outer wall 41. In this heater box 47, a gas supply clear aperture 49 is provided to supply neutral gas or inactive gas to the heat-treatment chamber 410. In FIG. 4, a gas supply pipe to the heat treatment furnace 31 and various sensors illustrated in FIG. 3 are omitted.

Since neutral gas or inactive gas pressurized to be slightly higher than 1 atmosphere is supplied to the heater box 47, the gas is supplied into the graphite outer muffle 42 through a gap between the graphite outer muffle 42 and the bush 46, and is further supplied to the heat-treatment chamber 410 through an unillustrated gap of the graphite inner muffles 43. Thus, the materials to be treated 317 laid on the mesh belt 44 are subjected to heat treatment under high temperature in a low-oxygen atmosphere gas constituted of neutral gas such as nitrogen gas or inactive gas such as argon gas and helium gas.

As described in the foregoing, the graphite heat insulator 41b, the graphite outer muffle 42, the graphite inner muffle 43, the graphite heater 45, and the mesh belt 44, which are main component members of the heat treatment furnace 31, are made of graphite materials. A small amount of residual oxygen contained in the atmosphere gas reacts with graphite and the like in the in-furnace structures and turns into carbon monoxide (CO), which is discharged out of the furnace together with the atmosphere gas. As a result, the residual oxygen partial pressure in the atmosphere gas is lowered. Under high temperature, metal oxides formed on the surface of the materials to be treated 317 are thermally dissociated into oxygen and metal, and the thermally dissociated oxygen is released into the atmosphere gas having a lowered oxygen partial pressure. This oxygen reacts with graphite and the like that constitute the inner wall of the graphite inner muffle 43 and the mesh belt 44, and turns into carbon monoxide (CO), which is swiftly discharged out of the furnace together with atmosphere gas. Thus, heat dissociation of metal oxides is continuously performed only with neutral gas or inactive gas without using the reducing gas.

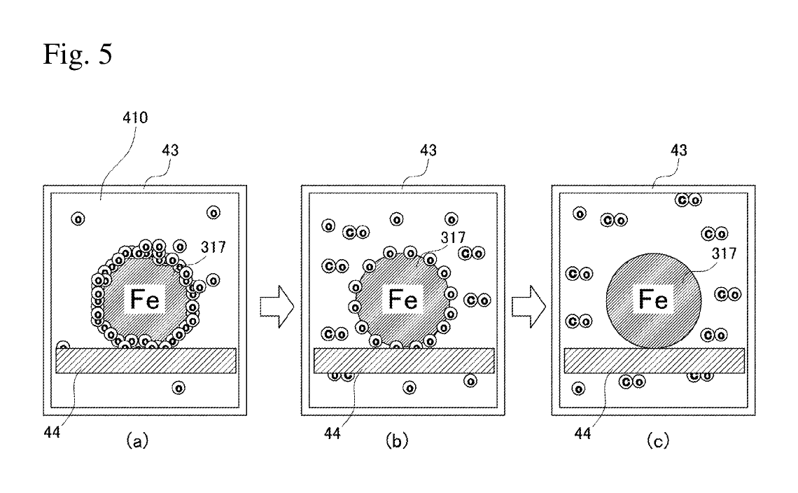

Now, the case where the materials to be treated 317 are iron (Fe) having oxidized surface and the bright treatment is performed thereon in the heat treatment furnace 31 will be described with reference to FIG. 5. FIG. 5(a) illustrates iron (Fe) having oxidized surface, which is laid on the mesh belt 44 made of a C/C composite material, together with a setter material (not illustrated) such as ceramics, in the heat-treatment chamber 410 surrounded with the graphite inner muffle 43 inside the heat treatment furnace 31. As atmosphere gas, neutral gas such as nitrogen gas or inactive gas such as argon gas and helium gas is supplied thereto.

As illustrated in FIG. 5(b), a small amount of residual oxygen contained in the atmosphere gas reacts with materials such as graphite materials which constitute the graphite inner muffle 43 or the mesh belt 44, and turns into carbon monoxide (CO), which is released to the outside of the heat treatment furnace 31 together with the atmosphere gas which also serves as carrier gas. As a consequence, the oxygen partial pressure in the atmosphere gas decreases, and according to an equilibrium oxygen partial pressure theory, oxygen which constitutes metal oxides cannot maintain metal oxidation state and spreads to the atmosphere. This oxygen reacts with graphite and the like which constitute the inner wall of the graphite inner muffle 43 and the mesh belt 44, and turns into carbon monoxide (CO), which is discharged out of the furnace together with the atmosphere gas as is the case of the residual oxygen. Accordingly, the oxygen partial pressure in the vicinity of the surface of metal oxides does not increase, so that an extremely low-oxygen partial pressure state, as low as 10⁻¹⁵ Pa or less, is continuously maintained.

As this reaction further progresses, all the oxygen on the front surface of iron reacts with carbon (C) and turns into carbon monoxide (CO), which is released to the outside of the heat treatment furnace 31 together with atmosphere gas as illustrated in FIG. 5(c). As a result, oxides on the surface of iron are completely dissociated by heat, by which the bright treatment is implemented.

As described in the foregoing, the method for heat treatment has characteristics as shown below.

1) The treatment can be performed in an inert atmosphere which is not explosible, so that safety is ensured.

2) The heat treatment is performed in neutral gas or in inactive gas, so that carburization and decarbonization phenomena of the materials to be treated do not occur.

3) The furnace can be operated under normal pressure, so that evaporation of metal to be treated can be suppressed more than evaporation in a vacuum method.

4) Since the oxygen partial pressure in the heat treatment furnace can be maintained extremely low, it becomes possible to perform heat dissociation of metal oxides, which are extremely difficult to reduce, and to thereby handle metal in a deoxidized state.

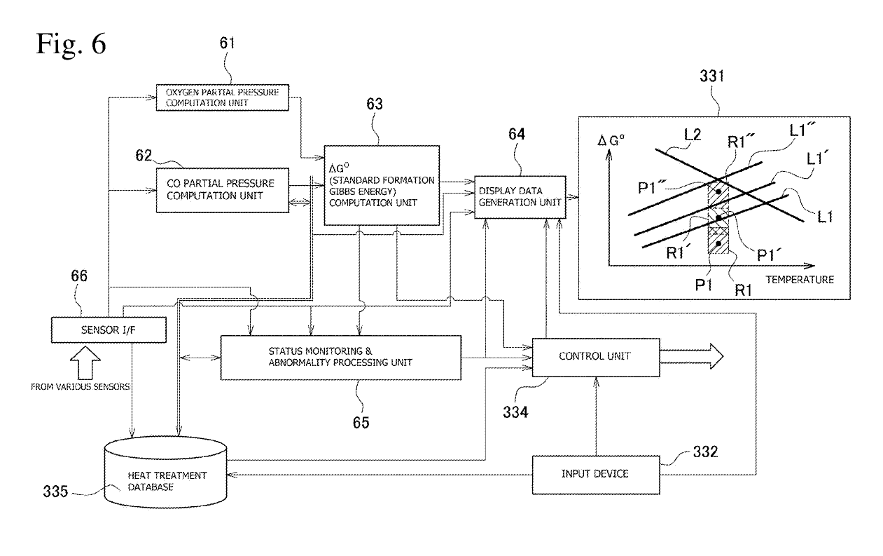

Next, the configuration and operation of the arithmetic processor 333 will be described with reference to FIGS. 3 and 6.

The arithmetic processor 333 includes a sensor I/F 66 that receives signals from various sensors, an oxygen partial pressure computation unit 61 that calculates oxygen partial pressure in the heat treatment furnace 31 with reference to a signal from the oxygen sensor 312 input via the sensor I/F 66, and a CO partial pressure computation unit 62 that calculates carbon monoxide partial pressure (CO partial pressure) with reference to a signal input from the CO sensor 313.

A ΔG⁰ (standard formation Gibbs energy) computation unit 63 refers to the calculation results calculated respectively in the oxygen partial pressure computation unit 61, the CO partial pressure computation unit 62 to calculate ΔG⁰ (standard formation Gibbs energy) of the heat treatment furnace 31 in operation, and outputs the calculation result to a display data generation unit 64, the control unit 334, and a status monitoring & abnormality processing unit 65.

There are several methods of calculating ΔG⁰, and some typical calculation methods will be described below.

ΔG⁰−RT·ln P(O₂) (1)

### [Reaction Among CO —O₂]

2C+O₂=2CO (2)

ΔG⁰(1)=−229810+171.5T (J−·mol⁻¹) (3)

ΔG⁰=RT ln P(O₂)=ΔG⁰(1)−2 RT ln P(CO) (4)

Here, R represents a gas constant, T represents absolute temperature, P(O₂) represents oxygen partial pressure (O₂ partial pressure), P(CO) represents carbon monoxide partial pressure (CO partial pressure).

In the above-stated formulas, ΔG⁰ can be calculated from the oxygen partial pressure P(O₂) by using the formula (1). The formula (2) represents a reaction among carbon (C), oxygen (O₂) while the formula (3) indicates that ΔG⁰ (standard formation Gibbs energy) in this system of reaction is calculated with a linear function of absolute temperature (T).

In accordance with the formula (4), RT ln P (O₂) can be calculated by using the carbon monoxide partial pressure (CO partial pressure), and therefore an oxygen partial pressure P (O₂) and ΔG⁰ can be obtained.

Next, the sensors necessary for calculation of ΔG⁰ will be described.

When attention is focused on the formula (1), ΔG⁰ can be calculated when the absolute temperature T and the oxygen partial pressure P(O₂) are detected. Therefore, the temperature sensor 311 and the oxygen sensor 312 may be provided.

When attention is focused on a CO—O₂ reaction to calculate ΔG⁰ (standard formation Gibbs energy) by using the formula (4), the carbon monoxide partial pressure (CO partial pressure) needs to be detected. Accordingly, the CO sensor 313 may be provided as a sensor.

Moreover, precision may be enhanced by such a method of calculating ΔG⁰=RT ln P(O₂) according to the formula (1) and RT ln P(O₂)=ΔG⁰(1)−2RT ln P(CO) according to the formula (4), and selecting a method estimated to have the highest precision, or averaging, weighted-averaging or statistically processing respective calculation results.

Returning to the description with reference to FIG. 6, the display data generation unit 64 uses ΔG⁰ (standard formation Gibbs energy) output from the ΔG⁰ computation unit 63, the temperature information input from the temperature sensor 311 via the sensor I/F 66, the Ellingham diagram corresponding to the material to be treated 317 specified by the input device 332, the information on the control range on the Ellingham diagram corresponding to the materials to be treated 317, and the like, to generate display data to be displayed on the display device 331. A plurality of Ellingham diagrams corresponding to the materials to be treated 317 that are various metals and alloys such as carbon steel, and steel, nickel (Ni), chromium (Cr), titanium (Ti), silicon (Si) and copper (Cu) containing an alloy element, and the information on the control ranges corresponding to these Ellingham diagrams are accumulated in the heat treatment database 335. Information on new materials to be treated and their control ranges is updated periodically or un-periodically.

The display device 331 displays the display data output from the display data generation unit 64 with temperature as an abscissa and ΔG⁰ as an ordinate, in which standard formation Gibbs energy of the materials to be treated 317 at respective temperatures is displayed as approximate straight lines L1, L1′ and L1″ while standard formation Gibbs energy in the reaction of 2C+O₂=2CO is displayed as an approximate straight line L2. Here, the approximation straight lines L1 represents standard formation Gibbs energy of titanium (Ti) and titanium oxide (TiO₂), the approximation straight lines L1′ represents standard formation Gibbs energy of iron (Fe) and iron oxide (Fe₂O₃), and the approximation straight lines L1″ represents standard formation Gibbs energy of copper (Cu) and copper oxide (Cu₂O), respectively.

Each metal has different standard formation Gibbs energy. The metals which locate at lower positions with respect to the ΔG⁰ axis are less susceptible to heat dissociation. For example, in the conventional heat treatment furnace with the oxygen partial pressure of 10⁻¹ Pa and the furnace temperature of 1600 K (1327° C.), only copper oxide (Cu₂O) is thermally dissociated into copper even when high purity neutral gas or inactive gas is used. Not only titanium, which is lower in standard formation Gibbs energy than copper, is not thermally dissociated, but also steel is not at all thermally dissociated.

Accordingly, in the past, vacuum methods have generally been used as a method of decreasing the oxygen partial pressure. In the atmosphere furnace, atmosphere gas containing reducing gas, such as hydrogen and carbon monoxide, has been used. However, these methods have a high possibility of causing failures as described in the foregoing. Contrary to this, the heat treatment furnace of the present invention can lower the oxygen partial pressure to 10⁻¹⁵ Pa or less in the atmosphere of normal pressure, which is constituted of only neutral gas or inactive gas. For example, when the oxygen partial pressure in the furnace is 10⁻¹⁹ Pa and the furnace temperature is 1600 K (1327° C.), iron oxides and titanium oxides are reduced by heat dissociation.

In a present invention, in accordance with the approximate straight lines L1, L1′, and L1″ of respective metals, control ranges R1, R1′, and R1″ and statuses P1, P1′ and P1″ in the heat treatment furnace 31 calculated by the ΔG⁰ (standard formation Gibbs energy) computation unit 63 are simultaneously displayed on an Ellingham diagram. The control ranges R1, R1′, and R1″ are set below the approximate straight lines L1, L1′, and L1″ and in the vicinity of the straight lines L1, L1′, and L1.″ For example, when the materials to be treated 317 are titanium, the control range R1 is read out from the heat treatment database 335 and are displayed on an Ellingham diagram together with the status P1 in the heat treatment furnace 31 calculated by the ΔG⁰ (standard formation Gibbs energy) computation unit 63. In the case of other metals, the control ranges set for the respective metals and their status points on the Ellingham diagram are similarly displayed.

The status P1, P1′, P1″ are updated at every sampling time by various sensors, e.g., at every second on a display screen. While the control ranges R1, R1′, R1″ and the status P1, P1′, P1″ are essential as the information displayed on the display device 331, the approximate straight lines L1, L1′, L1″ and the approximate straight line L2 are not necessarily essential in mass-production heat treatment apparatuses. Moreover, the update period may arbitrarily be set.

With reference to the Ellingham diagram displayed on the display device 331, an operator of the heat treatment apparatus illustrated in FIG. 3 can two-dimensionally understand the status of the heat treatment furnace 31 currently in operation. More specifically, if the status P1 is within the control range R1, it is determined that the heat treatment, such as the bright treatment, the refining treatment, the hardening/tempering treatment, brazing, and sintering, is normally processed, so that continues operation is performed. Contrary to this, when the status P1 is out of the control range R1, it is possible to recognize in real time that a certain abnormality occurs in the heat treatment furnace 31, and in the worst case scenario, the operation of the heat treatment apparatus is stopped, so that mass production of defective articles can be prevented.

The status monitoring & abnormality processing unit 65 monitors in real time the parameters including temperature, O₂ partial pressure, CO partial pressure in the heat treatment furnace 31 and ΔG⁰, while reading the control range R1 corresponding to the materials to be treated 317 and the like from the heat treatment database 335 and outputting an abnormal signal to the control unit 334 when the above-described parameters deviate from the specified control range.

As described above, the method for heat treatment, the heat treatment apparatus, and the heat treatment system according to the present invention can perform extremely stable operation on mass production, which also ensure economically efficient operation. More specifically, since heat treatment is performed by using neutral gas or inactive gas as atmosphere gas, complicated chemical reactions with the materials to be treated are not involved, so that the heat treatment is performed with simple chemical reactions. Accordingly, as compared with the methods of using hydrocarbon gas and the like, the heat treatment stably proceeds.

In the case of the reduction reaction illustrated in FIG. 5, time change in ΔG⁰ (standard formation Gibbs energy) is monitored. Accordingly, when ΔG⁰ converges to a fixed value, complete removal of oxygen on the surface of the materials to be treated and completion of the reduction reaction can be determined. As a result, since the heat treatment can be completed by minimal heat treating time, efficient operation can be achieved and energy efficiency for the heat treatment can also be improved.

In the above case, the arithmetic processor 333 can pre-estimate completion time of the reduction reaction based on time change in ΔG⁰. If this estimated time matches with the time, at which ΔG⁰ becomes a fixed value, based on the information from respective sensors, then the estimated time may be adopted as the completion time of the reduction reaction.

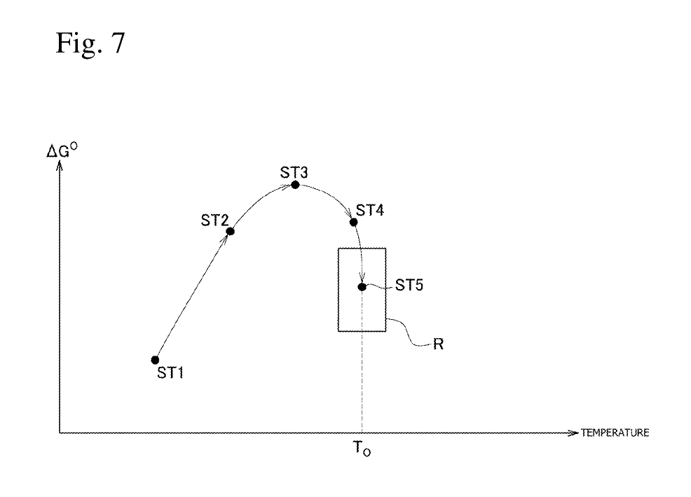

A description is now given of how the arithmetic processor 333 calculates the completion time of the reduction reaction based on time change in ΔG⁰ in the case where heat treatment is performed as batch treatment, with reference to FIGS. 5 and 7.

In FIG. 5, after the materials to be treated 317 are brought into the graphite inner muffle 43, a door (not illustrated) openably provided in a direction vertical to the page is closed to seal the heat treatment furnace 31 except for a gas supply clear aperture. Then, as mentioned above, reduction treatment of the materials to be treated 317 is chronologically executed in order of FIG. 5(a)->FIG. 5(b)->FIG. 5(c).

FIG. 7 describes time change in temperature and ΔG⁰. After the door is opened, gas inside the furnace is replaced with inactive (neutral) gas. After the temperature starts to increase, control is performed so that a status ST1 at about 600° C. shifts to statuses ST2, ST3, and ST4, before being stabilized in a status ST5. Specifically, as illustrated in FIG. 7, the temperature of the atmosphere gas in the heat treatment furnace 31 rapidly increases from a temperature (T1) of the status ST1 to a temperature (T2) of the status ST2, and then continues to increase relatively gradually to a temperature (T3) of the status ST3 and a temperature (T4) of the status ST4. The temperature of the heat treatment furnace 31 is set at T₀, to which the furnace temperature converges in the end.

Meanwhile, as illustrated in FIG. 7, ΔG⁰ rapidly increases from standard formation Gibbs energy ΔG⁰ (1) in the status ST1 to standard formation Gibbs energy ΔG⁰ (2) in the status ST2. This is because during the period from the status ST1 to the status ST2, oxygen on the surface of the materials to be treated 317 is rapidly released and thereby the oxygen partial pressure temporarily increases. According to the formula (2), the released oxygen bonds to carbon and turns into carbon monoxide (CO), which is discharged out of the furnace. As a result, ΔG⁰ decreases after the status ST3, and is eventually stabilized at the value of standard formation Gibbs energy ΔG⁰ (5) in the status ST5.

Therefore, the arithmetic processor 333 can calculate the completion time of the reduction reaction based on time change in ΔG⁰. In one example, the following method may be used. Based on time series data including sequential ΔG⁰ values, δ(n)=ΔG⁰(n)−ΔG⁰(n−1) is calculated. Here, ΔG⁰(n) and ΔG⁰(n−1) are values of ΔG⁰ at time n and at time n−1, respectively.

First, δ (n) takes a large negative value and then gradually decreases during a shift from the status ST2 to the status ST3. After the status ST3, δ (n) takes a positive value until it reaches the status ST4. During a shift from the status ST4 to the status ST5, δ (n) takes a positive value, and then gradually approaches 0, before being equal to 0 and stabilized in the status ST5. Since this relationship is not changed by various factors of the atmosphere gas or the materials to be treated 317, the completion time of the reduction reaction that sets ΔG⁰ equal to 0 can easily be calculated by using various approximate calculation methods.

When the reduction treatment of the materials to be treated 317 is finished according to the time calculated in this way, it is determined that normal heat treatment has been performed. Contrary to this, when the completion time deviates from the range of the calculated completion time, it is presumed that a certain abnormality has occurred and an audio or text alarm is output to the display device 331.

Moreover, when time change in ΔG⁰ or above-described δ (n) is out of the control range set for each time period during operation of the heat treatment, the flow rate of atmosphere gas or the flow velocity of the gas may be controlled to fall within a control range set for each subsequent time period.

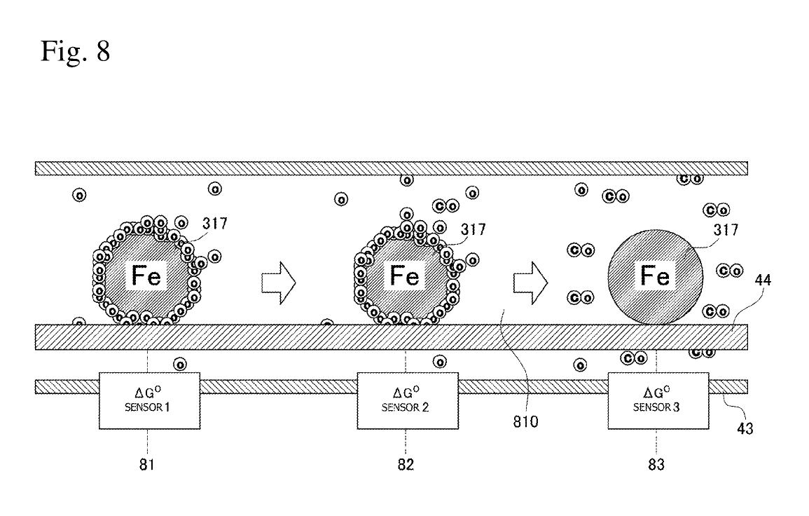

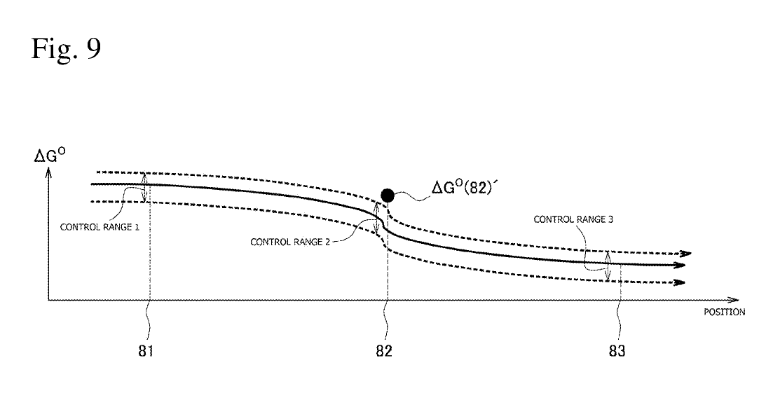

A description is now given of how the arithmetic processor 333 calculates the completion time of the reduction reaction based on time change in ΔG⁰ in the case where heat treatment is performed as continuous treatment, with reference to FIGS. 8 and 9.

FIG. 8 is an exemplary cross sectional view of a heat treatment furnace along a longitudinal direction when the heat treatment apparatus according to the present invention is applied to a continuous furnace. In FIG. 8, the materials to be treated 317 are laid together with a setter material (not illustrated), such as ceramics, on the mesh belt 44 in the graphite inner muffle 43. The materials to be treated 317 are moved from a left end to the right side together with the mesh belt 44. At a plurality of positions 81, 82, and 83 illustrated in FIG. 9 along the longitudinal direction of the heat treatment furnace 31, sensors including a ΔG⁰ sensor 1, a ΔG⁰ sensor 2, and a ΔG⁰ sensor 3 are provided for measuring ΔG⁰ at the respective positions. Specifically, sensors such as the oxygen sensor 312 or the CO sensor 313 illustrated in FIG. 3 are used as the respective ΔG⁰ sensors. They may be selected depending on the positions of the sensors to be used.

FIG. 9 illustrates change in ΔG⁰ with the position including positions 81, 82, and 83 in the continuous heat treatment furnace as an abscissa. The position 81 is equivalent to the position in the vicinity of an entrance of the heat-treatment chamber 810. Accordingly, oxygen on the surface of the materials to be treated 317 is rapidly released and thereby the oxygen partial pressure increases, so that the ΔG⁰ sensor 1 detects a high ΔG⁰ value. Since oxygen release from the surface of the materials to be treated 317 at the position 82 is slower than oxygen release at the position 81, ΔG⁰ at the position 82 is smaller than ΔG⁰ at the position 81. As the materials to be treated 317 is moved further to the position 83, oxygen release from the surface of the materials to be treated 317 is considerably reduced, so that ΔG⁰ at the position 83 decreases further.

Thus, the value of ΔG⁰ in the heat-treatment chamber 810 continuously changes, and each of the ΔG⁰ sensor 1, the ΔG⁰ sensor 2, and the ΔG⁰ sensor 3 outputs a signal equivalent to ΔG⁰ at each position to the control system 33 of FIG. 3. The status monitoring & abnormality processing unit 65 illustrated in FIG. 6 monitors in real time whether the ΔG⁰ value is within the control range. If the respective ΔG⁰ values at the positions 81, 82, and 83 are within the control ranges 1 to 3 of FIG. 9, it is determined that normal heat treatment is in progress. Contrary to this, assume that ΔG⁰(82) at the position 82 increases out of the control range 2 and reaches ΔG⁰(82)′ for example. This increase may be caused by various factors, such as oxide films of the materials to be treated 317 being thicker than expected, resulting in insufficient reduction treatment being performed prior to and at the position 82, and the residual oxygen partial pressure in atmosphere gas going up at the point when the standard formation Gibbs energy at the position 82 reaches ΔG⁰(82)′. In the early stage of the heat treatment, occurrence of an abnormality due to a certain cause is detectable in real time.

When the abnormalities described above occur, the control system 33 performs control to slow the conveyance rate of the mesh belt 44, increase the flow rate of atmosphere gas or the flow velocity of the gas, or to execute these two processes at the same time so that ΔG⁰ is within the control range 3 in the end. The method of slowing the conveyance rate of the mesh belt 44 involves taking longer time to perform reduction treatment of the materials to be treated 317. The method of increasing the flow rate of atmosphere gas or the flow velocity of the gas involves decreasing the residual oxygen partial pressure in atmosphere gas and thereby increasing a reduction treatment rate. By applying these methods, the abnormalities of heat treatment are detected at the early stage, and the conveyance rate of the mesh belt 44, the flow rate of atmosphere gas, or the flow velocity of the gas are controlled, so that stable heat treatment is performed. This makes it possible to reduce a rejection rate.

Next, the heat treatment database 335 illustrated in FIGS. 3 and 6 will be described in detail.

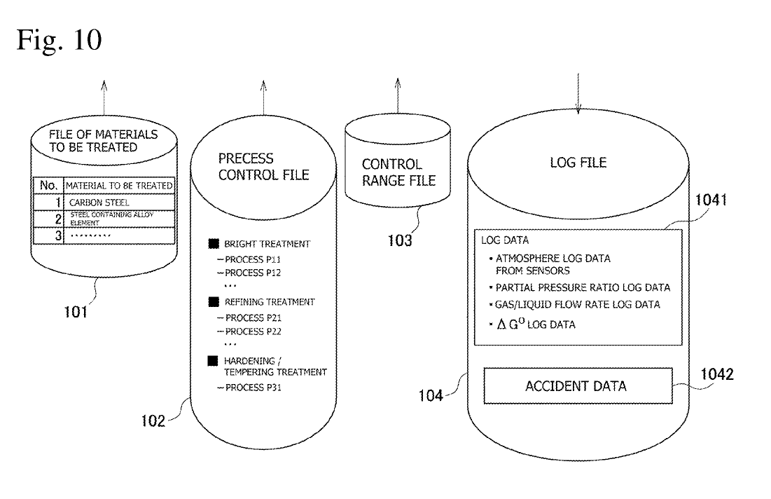

The heat treatment database 335 includes, as illustrated in FIG. 10, a file of materials to be treated 101, a process control file 102, a control range file 103, and a log file 104. The file of materials to be treated 101 prestores the materials to be treated 317, which are subjected to heat treatment in the heat treatment furnaces 31, together with their numbers in a table format or as a library. As the materials to be treated, various materials such as various metals and alloys, including carbon steel, and steel, nickel (Ni), chromium (Cr), titanium (Ti), silicon (Si) and copper (Cu) containing an alloy element are stored.

The process control file 102 stores specific process names, such as a bright treatment, a refining treatment, a hardening/tempering treatment, brazing, and sintering, and process conditions corresponding to the process names in a table format or as a library for each material to be treated 317. The process conditions to be stored include, as respective initial values, temperature of the heat treatment furnace 31, CO partial pressure, O₂ partial pressure, ΔG⁰ as a result of computation in the ΔG⁰ (standard formation Gibbs energy) computation unit 63, a flow rate of neutral gas or inactive gas or a flow velocity of the gas in the flowmeter 322, a conveyance rate of the materials to be treated 317, and time control and process sequences of these parameters.

Based on an instruction from the input device 332, the arithmetic processor 333 read from the heat treatment database 335, a table or library specified from the file of materials to be treated 101 and the process control file 102 which are stored in the form of a table or a library, and displays the table or library on the display device 331. An operator confirms the displayed content, and if the displayed heat treatment conditions are acceptable, the operator starts the heat treatment under the conditions. Therefore, in the case of changing the heat treatment, the heat treatment can easily be changed based on the above-described procedures, so that the heat treatment such as the bright treatment, the refining treatment, and the hardening/tempering treatment, brazing, and sintering can promptly and flexibly be implemented.

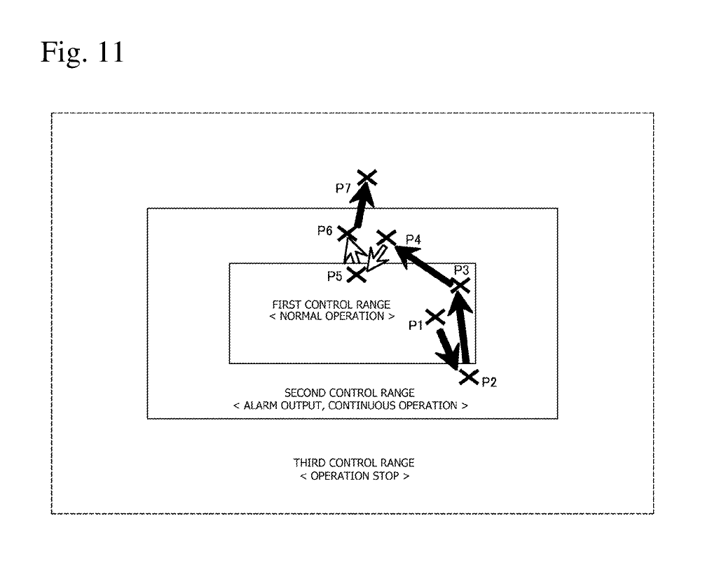

As illustrated in FIG. 11, the control range file 103 is constituted of: a first control range indicative of a normal operation range; a second control range set outside the first control range, the second control range representing an operation range with caution required, though the second control range is out of the normal operation range; and a third control range set further outside the second control range, in which operation of the heat treatment furnace 31 is stopped. In FIG. 11, temperature represents an abscissa while ΔG⁰ represents an ordinate of the control range. Although the shape of the control range is rectangular in FIG. 11, the shape is not necessarily limited thereto, and arbitrary shapes such as polygons and ellipses may also be used.

In FIG. 11, the second control range is provided adjacent to the outside of the first control range, and the third control range is provided adjacent to the outside of the second control range. However, they do not necessarily need to be provided adjacent to each other, and a buffer region may be provided between the respective control ranges.

The log file 104 has a log data file 1041 that stores parameters from respective sensors in real time, the parameters including temperature of the heat treatment furnaces 31, CO partial pressure, O₂ partial pressure, and a flow rate or flow velocity of gas or liquid passing through the flowmeter 322, a conveyance rate of the material to be treated 317, and ΔG⁰. The log file 104 also has an accident data file 1042 including the above log data file for the second control range and third control range illustrated in FIG. 11.

The log file 74 is divided into the log data file 1041 and the accident data file 1042, so that the accident data file 1042 is preferentially analyzed when an accident occurs. As a result, accident analysis can efficiently be carried out.

Now, the control unit 334 will be described with reference again to FIG. 6. The control unit 334 inputs temperature T input from the temperature sensor 311 via the sensor I/F 66, and reads a specified temperature T0 from the process information stored in the heat treatment database 335 specified through the input device 332 to control electric current passed to the heater 316 so that ΔT (=T−T0) is equal to 0, i.e., the temperature T is matched with the temperature T0.

By using ΔG⁰ from the ΔG⁰ (standard formation Gibbs energy) computation unit 63 and the information on the control range R1, the control unit 334 controls the flow control valve 321 to control the gas flow rate or the gas flow velocity so that the status expressed by ΔG⁰ is aligned with the center of the control range. The control ranges R1, R1′, and R1″ are regions each set below the approximate straight lines L1, L1′, and L1″, where the materials to be treated 317 are reduced. At the same time, the control ranges R1, R1′, and R1″ are set below the approximate straight line L2. As long as atmosphere gas is controlled to be in these control ranges R1, R1′, and R1″, carbon (C) is also in the reduction region, so that a failure that decarbonization occurs due to oxidation of carbon present on the surface of the materials to be treated 317 is prevented.

The atmosphere gas inside the heat treatment furnace 31 is more oxidizing as ΔG⁰ is higher in the Ellingham diagram, whereas the atmosphere gas is more reducing as ΔG⁰ is lower in the Ellingham diagram. When the flow rate of the neutral gas or inactive gas or the flow velocity of the gas to be supplied to the heat treatment furnace 31 is controlled by controlling the flow control valve 321 of FIG. 3, the amount of carbon monoxide (CO), which is generated in FIGS. 5(a), 5(b), and 5(c) and discharged out of the furnace of the heat treatment furnace 31, is changed. Consequently, the carbon monoxide (CO) partial pressure in the heat-treatment chamber 410 illustrated in FIG. 4 is changed. Therefore, by controlling the flow rate of the neutral gas or inactive gas or the flow velocity of the gas to be supplied to the heat treatment furnace 31, the statuses P1, P1′, and P1″ on the Ellingham diagram shift upward or downward, though a failure, such as carburization of the materials to be treated 317 due to generation of soot caused by excessive inflow of hydrocarbon gas, is prevented. Similarly, the atmosphere gas of the heat treatment furnace 31 is neutral gas or inactive gas, which prevents decarbonization caused by the surface of the materials to be treated 317 reacting with the atmosphere gas that is oxidizing gas.

The description has been given of the case where the control unit 334 controls the flow control valve 321 so as to control the gas flow rate or the gas flow velocity so that the status expressed by ΔG⁰ is aligned with the center of the control range. However, the conveyance rate of the mesh belt 44 may be controlled so that the status expressed by ΔG⁰ is aligned with the center of the control range. More specifically, as the conveyance rate of the mesh belt 44 is slowed, the reducing time becomes longer, which enables the materials to be treated 317, which need longer reduction treatment time, to be sufficiently reduced. On the contrary, for the materials to be treated 317 which can be reduced in short reduction treatment time, the conveyance rate of the mesh belt 44 is increased, so that the heat treatment efficiency of the furnace can be enhanced.

When serious abnormalities occur in operation of the furnace, the control unit 334 stops operation of the heat treatment apparatus by such an action as stopping a conveyance mechanism that conveys the materials to be treated 317 to the heat treatment furnace 31, based on the information from the status monitoring & abnormality processing unit 65.

When serious abnormalities occur, the control unit 334 outputs an abnormal signal to the display data generation unit 64. Upon reception of the signal, the display data generation unit 64 executes alarm processing such as blinking the status P1, P1′, P1″ displayed on the display device 331 or issuing an alarm sound.

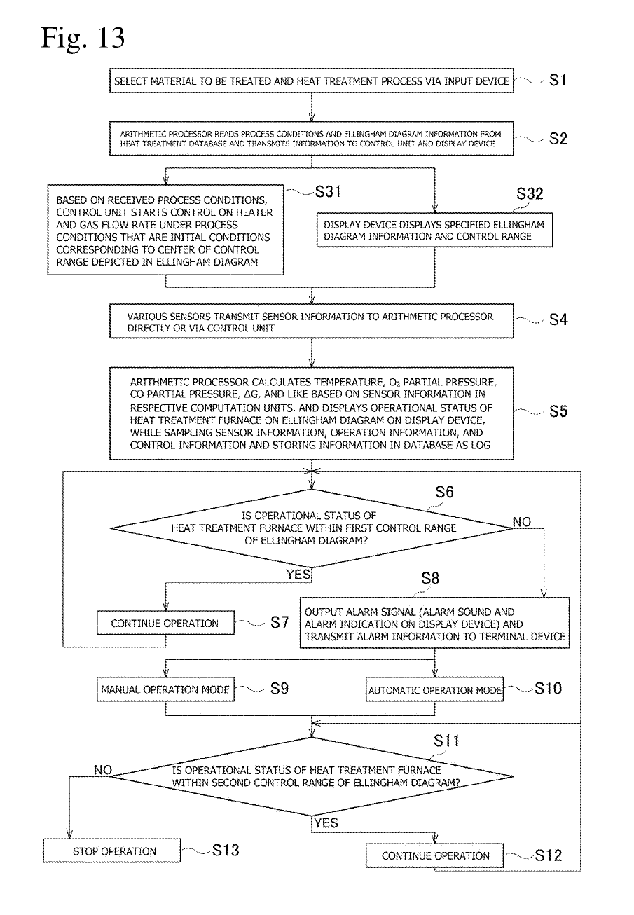

A description is now given of the method for heat treatment and the heat treatment apparatus of the present invention with reference to a flow chart illustrated in FIG. 13 and with reference to FIGS. 3 and 6 to 15.

In step S1, by using the input device 332, the materials to be treated 317 that are heat treatment target this time and a heat treatment process therefor are selected from a menu displayed on the display device 331. For example, carbon steel is selected as the materials to be treated 317, and P1 process is selected from the bright treatment as a heat treatment process.

Next, in step S2, the arithmetic processor 333 read process conditions, Ellingham diagram information, and a control range from the heat treatment database 335, and output these pieces of information to the control unit 334 and the display device 331. In step S31, based on the received process conditions, the control unit 334 starts to control the gas flow rate or the gas flow velocity by controlling the heater 316, the flow control valve 321, and the like, so that the temperature and ΔG⁰ are positioned in the center of the control range displayed in the Ellingham diagram. At the same time, the display device 331 displays the Ellingham diagram information and the control range in step S32.

Next, in step S4, various sensors output the detected sensor information to the arithmetic processors 333 directly or via the control unit 334. In step S5, the arithmetic processor 333 generates ΔG⁰ calculated by the formula (1) or (4) with reference to the oxygen partial pressure (O₂ partial pressure) and the carbon monoxide partial pressure (CO partial pressure) calculated in the respective computation units 61 and 62, or ΔG⁰ calculated based on computation results of the plurality of formulas, as display data to be displayed on the Ellingham diagram of the display device 331 together with the control range and the approximate straight lines L1, L1′, L1″ and L2 illustrated in FIG. 6. At the same time, sensor information from the temperature sensor 311, the oxygen sensor 312, the flowmeter 322 and the like, computation information such as oxygen partial pressure (O₂ partial pressure) as a result of computation in the oxygen partial pressure computation unit 61, carbon monoxide partial pressure (CO partial pressure) as a result of computation in the CO partial pressure computation unit 62, ΔG⁰ as a result of computation in the ΔG⁰ (standard formation Gibbs energy) computation unit 63, drive current for the heater 316, and control information such as flow control information for the flow control valve 321 are respectively stored in real time as the log data file 1041.

Next, in step S6, the status monitoring & abnormality processing unit 65 determines whether or not the operational status of the heat treatment furnace 31 is within the control range of the Ellingham diagram. When the operational status is within the control range of the Ellingham diagram, the status monitoring & abnormality processing unit 65 instructs the control unit 334 to continue operation. In step S7, the control unit 334 outputs control information for continuous operation to an unillustrated conveyance mechanism for the materials to be treated 317, the heater 316, and the flow control valve 321.

Contrary to this, when the operational status is out of the control range of the Ellingham diagram, the status monitoring & abnormality processing unit 65 instructs the display data generation unit 64 to execute alarm processing such as blinking the status P1, P1′, P1″ on the display device 331 or issuing an alarm sound. At the same time, as illustrated in FIG. 3, alarm information is transmitted to the terminal device 34 which is distant from the heat treatment furnace 31 via the communication line 35 in real time.

As a consequence, when the status P1, P1′, P1″ are out of the first control range, an urgent mail or the like is sent to the PC of a production management engineer and the like, so that the production management engineer can quickly access the accident data file 1042 in the heat treatment database 335. The production management engineer analyzes the data in the accident data file 1042 by using an accident analysis tool to find out the cause of the accident, and gives instructions to a production site to cope with the situation.

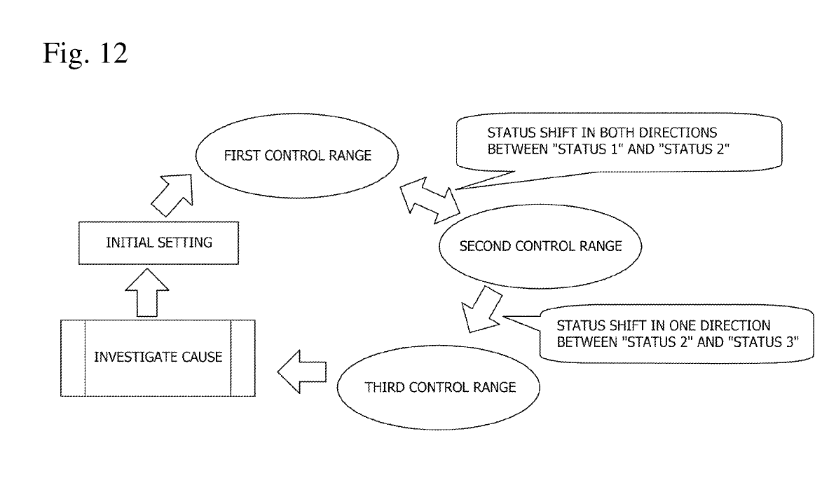

Next, the processing in the case where the operational status of the heat treatment furnace 31 is out of the first control range of the Ellingham diagram in step S6 will be described in detail with reference to FIGS. 11 and 12.

When the status shifts from the first control range indicative of the normal operation to the second control range, the status monitoring & abnormality processing unit 65 instructs the display data generation unit 64 to execute alarm processing in step S8. At the same time, the status monitoring & abnormality processing unit 65 transmits alarm information to the terminal device 34 in real time via the communication line 35.

When the status shifts from the first control range to the second control range, the control unit 334 performs feedback control in real time so that the status returns to the first control range. As illustrated in FIG. 12, the status can shift in both directions between the first control range and the second control range. Operation modes in the second control range include: an automatic operation mode shown in step S10 in which the control unit 334 automatically performs all the control operations; and a manual operation mode shown in step S9 in which an operator or an engineer manually gives instructions to the control unit 334 to operate the heat treatment apparatus. Whether to select the automatic operation mode or the manual operation mode is instructed to the arithmetic processor 333 through the input device 332, and mode change is performed accordingly.

When the status goes into the third control range (No in step S11), operation of the heat treatment furnace 31 is stopped as illustrated in step S13 in both of the automatic operation mode and the manual operation mode so as to prevent production of defective articles. Specifically, a conveying operation of a conveyor or a roller that conveys the materials to be treated 317 is stopped to prevent new materials to be treated 317 from being input into the heat treatment furnace 31. Once the status goes into the third control range as illustrated in FIG. 12, it is difficult for the status to return to the second control range, and therefore it is a general course of action to investigate the cause of the accident and to restart the heat treatment apparatus from initial setting.

When it is determined in step S11 that the operational status of the heat treatment furnace 31 is within the second control range of the Ellingham diagram, operation is continued in step S12, and in step S6 or step S11, continuous monitoring of the operational status is performed to check which control range the status is positioned at.

To provide more detailed description with respect to the above-described operation, consider the case where the status P1 in the first control range shifts to a status P2 in the second control range in FIG. 11. The status P2 indicates that ΔG⁰ is lower than that in the status P1 in the Ellingham diagram, i.e., the status P2 has a higher reducing property. Accordingly, the control unit 334 controls to decrease the flow rate of neutral gas or inactive gas or the flow velocity of the gas so as to lower the reducing property of atmosphere gas.

More specifically, when the flow rate of neutral gas or inactive gas or the flow velocity of the gas is decreased, decrease in carbon monoxide partial pressure (CO partial pressure) in the atmosphere is suppressed. Therefore, a reaction from the left hand side to the right hand side in formula (2) is suppressed. Accordingly, as the flow rate of neutral gas or inactive gas or the flow velocity of the gas to be supplied to the heat treatment furnace 31 is decreased, the reducing property of atmosphere gas is lowered, and the status point shifts upward in the Ellingham diagram.

Back to FIG. 11, although the status P2 goes into the first control range again and shifts to a status P3, the status P3 soon goes into the second control range and shift to a status P4. When such status shift is repeated and a status P6 in the second control range shifts to a status P7 in the third control range, it is generally difficult to shift from the status in the third control range to the status in the second control range. Accordingly, at the moment when the status shifts to the status P7, operation of the heat treatment furnace 61 is stopped.

As described in the foregoing, the control range is divided into the first control range to the third control range, and the control method is adjusted for each range, so that decrease in occurrence rate of defective lots and reduction in operation stop period are achieved. As a consequence, the heat treatment apparatus excellent in mass productivity can be provided.

In FIG. 11, temperature is used as an abscissa. While a wide temperature control range is schematically illustrated for easier understanding, an actual temperature control range is set at several to several ten degrees.

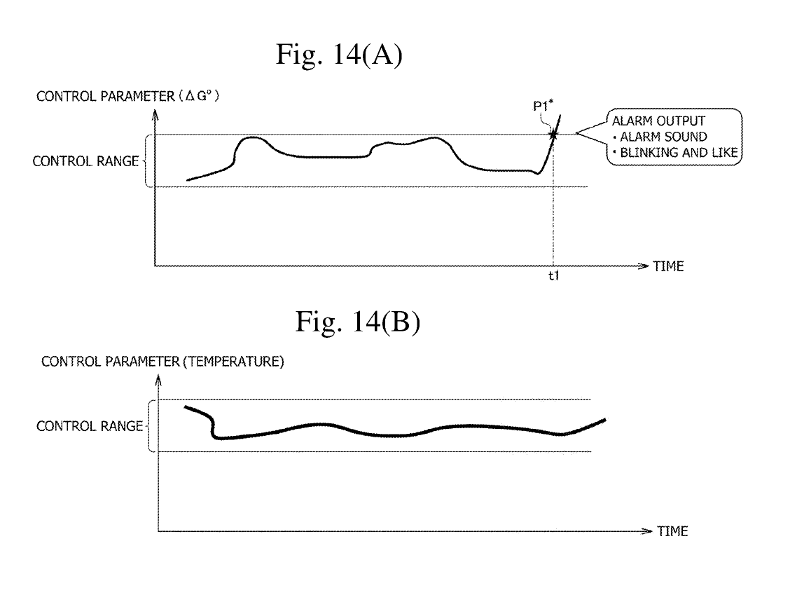

While FIG. 11 illustrates a two-dimensional control range with temperature as an abscissa and ΔG⁰ as an ordinate, FIGS. 14(A) and 14(B) illustrate these two parameters in the form of two different charts. FIG. 14(A) illustrates status change by using time as an abscissa and ΔG⁰ as an ordinate. Up to time t1, ΔG⁰ is within the control range, but at the time t1, ΔG⁰ exceeds an upper limit of the control range. In response to this event, the display data generation unit 64 executes alarm processing such as blinking a status P1* on the display device 331 or issuing an alarm sound. Although the case of using ΔG⁰ as a control parameter has been described in FIG. 14(A), residual oxygen partial pressure may be used as a control parameter and alarm processing may be executed when the residual oxygen partial pressure exceeds an upper control limit value.

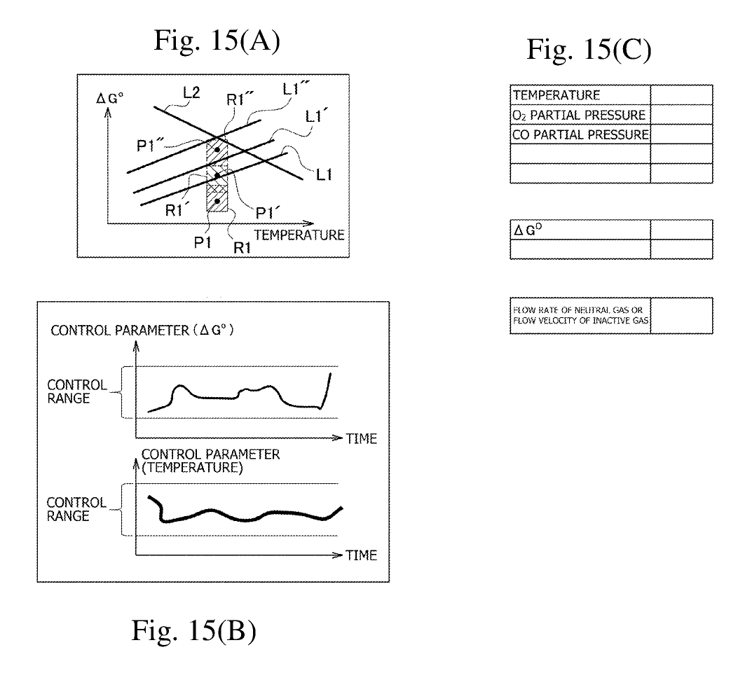

FIG. 15 illustrates information (A) to (C) displayed on an identical screen or a plurality of screens of the display device 331 illustrated in FIG. 3, the information (A) indicating the status in the Ellingham diagram, the information (B) indicating time transition in control parameter, and the information (C) indicating sensor information from the sensors, their computation values, gas control information, and the like. The information (A) is effective for two-dimensional understanding of a current status from a perspective of the Ellingham diagram, while the information (B) is effective for understanding how the control parameter changes with time. For example, the sensor output from the output gas sensor 323 is time-serially displayed, and when the sensor output is out of the control range, it is determined that an abnormality occurs in the gas supply device 32 and an alarm is output.

Meanwhile, the information FIG. 15(C) displays detailed control parameters in the status indicated in FIG. 15(A) or FIG. 15(B).

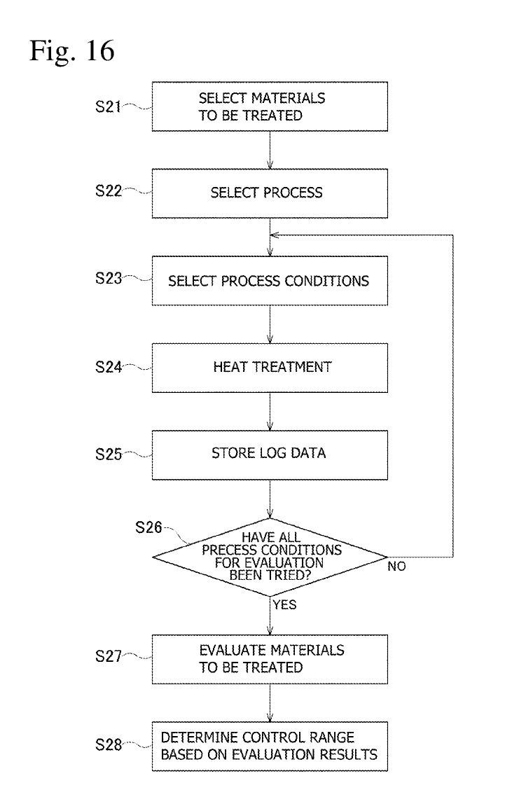

The method for heat treatment and the heat treatment apparatus according to the present invention are controlled by using the control range in the control range file 103 illustrated in FIG. 10. Accordingly, a method of determining the control range will be described with reference to FIG. 16.

In step S21, a material to be treated, which is subjected to evaluation for determination of the control range, is selected from various materials to be treated, such as various metals and alloys including carbon steel, and steel, nickel (Ni), chromium (Cr), titanium (Ti), silicon (Si) and copper (Cu) containing an alloy element. In step S22, a process suitable for the material to be treated which is selected in step S22, e.g., a process P1 of the bright treatment or the like, is selected. Next, in step S23, a plurality of process conditions for evaluation are prepared based on default process conditions of the selected process. Then, one process condition is selected from these process conditions for evaluation, and in step S24, the materials to be treated 317 are heat-treated by using the heat treatment apparatuses illustrated in FIG. 3 and the method for heat treatment illustrated in FIG. 13.

Next, in step S25, parameters including temperature of the heat treatment furnace 31, O₂ partial pressure, CO partial pressure, gas flow rates or gas flow velocity from the flowmeter 322, and ΔG⁰ are each stored as evaluation log data in the log data file 1041.

In step S26, it is determined whether or not all the process conditions for evaluation are tried. If all the process conditions for evaluation are not tried, a process condition for evaluation which is not yet tried is selected in S23, and processing in steps S24 and S25 is repeated so as to repeat the heat treatment in all the process conditions for evaluation.

In step S27, each material to be treated which is heat-treated in each process for evaluation is evaluated. Specifically, color, surface hardness, presence/absence and degree of decarbonization and carburization, crystal structure based on X-ray diffractometry, shear strength of a joined part after brazing, and the like are evaluated for each material to be treated. Based on the evaluation result, a control range which satisfies target specifications is determined in step S28.

As specifically described in the foregoing, based on the flow of FIG. 16, preferred control ranges are determined for various materials to be treated and processes, and the determined preferred control ranges are stored in the control range file 103 as a library. Since the heat treatment apparatus of the present invention uses this library, the heat treatment apparatus capable of performing flexible heat treatment can be provided.

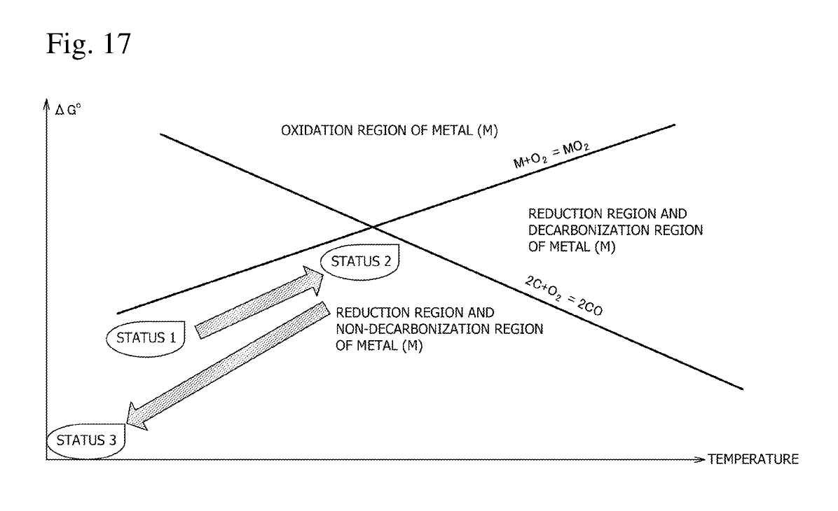

A description is now given of other embodiments of the heat treatment apparatus of the present invention with reference to FIG. 17.

FIG. 17 illustrates status shift in order of status 1->status 2->status 3 as the materials to be treated 317 receive different heat treatments. For example, it is respectively indicated that the heat treatment in the status 1 is a heat treatment in a residual heat zone, the heat treatment in the status 2 is a heat treatment performed in a heating zone, and the heat treatment in the status 3 is a heat treatment in a cooling zone. The materials to be treated 317 move inside a continuous furnace by the conveyance mechanism such as a conveyor belt or a roller, so that the materials are heat-treated at temperatures and in atmosphere gases different by zone.

When a lot number of the materials to be treated 317 is specified through the input device 332, it is possible to instantly display on the display device 331 which zone and which status on the Ellingham diagram the materials to be treated 317 of that lot number are present, together with the position of the zone and the process conditions. As for the lot in the cooling zone, an Ellingham diagram in the heating zone where the lot was previously heat-treated can be traced back and displayed.

In the above description, various gases including neutral gas such as hydrocarbon gas, and inactive gas such as argon gas and helium gas are supplied to the gas supply device from unillustrated gas supply sources, such as tanks, provided outside the gas supply device.

### REFERENCE SIGNS LIST

11 Exothermic converted gas generator
12 Dehumidifier
13 Gas mixer
14 Hydrocarbon gas feeder
15 Gas converter with heating function
16 Gas quenching/dehumidifier system
17 Bright annealing furnace
18 Oxygen potentiometer
19 Carbon potential computation controller
21 Heat chamber
22 Oxygen analyzer
23 Carbon monoxide analyzer
24 Oxygen partial pressure setting unit
25 Carbon monoxide partial pressure setting unit
31 Heat treatment furnace
311 Temperature sensor
312 Oxygen Sensor
313 CO Sensor
315 Gas sampling device
316 Heater
317 Material to be treated
32 Gas supply device
321 Flow control valve
322 Flowmeter
323 Output gas sensor
33 Control system
331 Display device
332 Input device
333 Arithmetic processor
334 Control unit
335 Heat Treatment Database
34 Terminal Device
35, 36 Communication Line
41 Outer wall
41a metal outer wall
41b Graphite heat insulator
42 Graphite outer muffle
43 Graphite inner muffle
44 Mesh belt
45 Graphite heater
46 Bush
47 Heater box
48 Metal plate material
49 Gas supply clear aperture
410 Heat-treatment chamber
61 Oxygen partial pressure computation unit
62 CO partial pressure computation unit
63 ΔG⁰ (standard formation Gibbs energy) computation unit
64 Display data generation unit
65 Status monitoring & abnormality processing unit
66 Sensor I/F
101 File of materials to be treated
102 Process control file
103 Control range file
104 Log File
1041 Log Data File
1042 Accident Data File

1. A heat treatment apparatus for a heat treatment, which is at least one of a bright heat treatment, a thermal refining treatment, a hardening/tempering treatment, brazing, and sintering, comprising:
a heat treatment furnace configured to heat-treat a material to be treated;
a gas supply device comprising a flow control valve for supplying atmosphere gas constituted of neutral gas or inactive gas to the heat treatment furnace;
a control system configured to control a flow rate from the gas supply device by referring to sensor information from a plurality of sensors for detecting a status of heat treatment in the heat treatment furnace, and
a terminal device that displays a display data via a communication line and transmits control information for controlling the control system;
wherein the heat treatment furnace has in-furnace structures made of graphite such that the heat treatment can be carried out in a low-oxygen atmosphere gas,
wherein the control system comprises:
a standard formation Gibbs energy computation unit configured to calculate standard formation Gibbs energy (ΔG⁰) of the atmosphere gas in the heat treatment furnace in reaction of 2C+O₂−2CO by referring to information from a CO sensor and a temperature sensor contained in the sensors, the CO sensor configured to sample a part of the atmosphere gas in the heat treatment furnace with a gas sampling device and to measure CO partial pressure inside the heat treatment furnace based on the sampled atmosphere gas; and
a display data generation unit configured to use an Ellingham diagram corresponding to the material in the heat treatment furnace and the calculated standard formation Gibbs energy to generate the display data to be displayed on a display device, the display data generation unit generating the display data such that a status of the calculated standard formation Gibbs energy is displayed on the Ellingham diagram on a display screen of the display device and is updated in real time on the display screen; and
a control unit configured to control the flow control valve of the gas supply device such that the calculated standard formation Gibbs energy falls within a control range set on the Ellingham diagram, and
wherein the control range is in a region set below an approximate straight line as which standard formation Gibbs energy of the material to be treated at respective temperatures is displayed, and is in a region set below the approximate straight line as which standard formation Gibbs energy in the reaction of 2C+O₂=2CO is displayed.

2. The heat treatment apparatus according to claim 1, wherein
the material to be treated includes at least one of carbon steel, steel containing an alloy element, nickel (Ni), chromium (Cr), titanium (Ti), silicon (Si) and copper (Cu).

3. The heat treatment apparatus according to claim 1, wherein
the control system is configured to calculate reduction finish time of the material to be treated based on time change in the standard formation Gibbs energy.

4. The heat treatment apparatus according to claim 1, further comprising:
a conveyance mechanism that conveys a plurality of the materials to be treated in sequence in a longitudinal direction of the heat treatment furnace; and
respective sensors in a plurality of places along the longitudinal direction to detect the status of heat treatment to calculate the standard formation Gibbs energy,
wherein the standard formation Gibbs energy is calculated in the respective places with reference to respective signals from the plurality of sensors, and a conveyance rate is controlled by the conveyance mechanism, or a flow rate of the neutral gas or inactive gas or a flow velocity of the gas is controlled, so that the calculated value falls within the control range.

5. The heat treatment apparatus according to claim 1, wherein
the display data generation unit is configured to generate the display data including the control range in the Ellingham diagram.

6. The heat treatment apparatus according to claim 1, further comprising
a heat treatment database that stores at least one of process information on the materials to be treated, log information about operation of the heat treatment apparatus, and accident information.

7. The heat treatment apparatus according to claim 1, wherein
the control range includes:
a first control range indicative of a normal operation range of the heat treatment furnace;
a second control range outside the first control range; and
a third control range outside the second control range,
wherein the control system further comprises a status monitoring & abnormality processing unit configured to monitor the status of the calculated standard formation Gibbs energy on the Ellingham diagram, and
wherein the status monitoring & abnormality processing unit is configured to output an alarm when the status of the calculated standard formation Gibbs energy on the Ellingham diagram deviates from the first control range, and to output control information so as to stop the operation of the heat treatment apparatus when the status of the calculated standard formation Gibbs energy on the Ellingham diagram shifts to the third control range.

8. The heat treatment apparatus according to claim 1, wherein
the heat treatment furnace comprises:
a tunnel-like graphite outer muffle formed from graphite, which is placed inside a hollow surrounded with a graphite heat insulator;
a tunnel-like graphite inner muffle formed from graphite, an inside of the graphite inner muffle serving as a heat-treatment chamber in which heat treatment of the material to be treated is performed;
a mesh belt made of a C/C composite material provided so as to be movable inside the heat-treatment chamber of the graphite inner muffle, the material to be treated being laid on the mesh belt; and
graphite heaters, which are placed outside the graphite inner muffle to heat the heat-treatment chamber, each of the graphite heaters being made to pass through the graphite outer muffle.
